(19) United States
(12) Patent Application Publication
(10) Pub. No.: US 2003/0154873 A1
(43) Pub. Date: Aug. 21, 2003

(54) Device for clamping or tensioning

(76) Inventors: Gianpaolo Pezzetta, an der Weinstrasse (DE); Martin Heinz Schoeps, Guntersleben (DE)

Correspondence Address: Douglas R Hanscom, Jones Tullar & Cooper, Eads Station, PO Box 2266, Arlington, VA, 22202, US

(21) Appl. No.: 10/275,969

(22) PCT Filed: May 15, 2001
(86) PCT No.: PCT/DE01/01832

(30) Foreign Application Priority Data
May 17, 2000 (DE) 10024331.2

(51) Int. Cl. B41F 27/12

(52) U.S. Cl. 101/415.1

(57) ABSTRACT

Rotatable shafts that are configured as profiled shafts or as spindles provided with cams or pressure pieces are used to actuate devices for retaining and/or tensioning in cylinders, especially in cylinders or printing machines. Such shafts require in addition to a device for actuating the clamping and/or tensioning device also a locking device for securing them against unintentionally twisting or releasing them and for the defined adjustment of their position. The aim of the invention is therefor to provide a single means for clamping or tensioning as well as locking the shaft. To this end, the device can be swiveled in the peripheral direction of the shaft for tensioning/clamping it, and about an axis that is substantially perpendicular to the swivel axis of the shaft for locking the shaft. For adjusting and fixing a defined position of the shaft (04) and for locking it with respect to its direction of swiveling a pawl (21) interacts with a pair of stops (24,26) in the locking position (A).

The invention relates to a device for clamping and/or tensioning.

DE 195 09 561 C2 discloses a device for clamping plates, having a swiveling spindle, wherein the plates are frictionally held between the channel wall and pressure cams arranged radially in the spindle. Clamping is performed by turning the swiveling spindle until the cams acts almost normally on the plates resting against the channel wall. In a similar manner DE 40 05 093 C1 shows an eccentrically seated spindle, which frictionally clamps the plates between its surface shell and the channel wall when the spindle is turned.

A device for actuating a tensioning device is known from DE 34 01 760 A1, wherein the tensioning spindle is designed as a profiled shaft. Tensioning takes place by turning the head of the tensioning spindle which projects past the front face of the cylinder and displaces a tensioning strip in the circumferential direction. The spindle is non-positively secured against an automatic return movement by pressing the surface of a pin of the spindle into a bracket.

U.S. Pat. No. 4,495,865 shows as device for the positive arresting of a device for tensioning packings on cylinders by turning a spindle. A crown gear is assigned to one of the ends of the spindle. Arresting is performed by means of a blade, which is placed nearly tangentially against the crown gear, wherein the shape of the teeth and the arrangement of the blade have been selected in such a way that turning of the spindle in the tensioning direction is possible, but a return movement is prevented. For releasing the device, the blade is pivoted away from the crown gear by actuating a lever assigned to the blade.

DE 44 42 300 A1 also shows a device for tensioning packings, which has an arresting device which in the operating state permits turning in the tensioning direction, but blocks a return movement. Tensioning and arresting, or releasing, here takes place by a single actuating means arranged in an extension of the spindle and which is turned for tensioning the packing in the circumferential direction of the spindle, and for arresting/releasing is moved axially in respect to the spindle axis. No limitation of the travel or force in the tensioning direction is not provided.

DE 29 10 880 C2 also discloses a device for tensioning a packing, wherein the tensioning of a packing and the arresting of a shaft takes place by means of a single device. Tensioning and arresting by means of the friction of a threaded bolt arranged in a screw thread takes place by means of the same movement.

A device for clamping/tensioning a packing and for arresting the device is known from U.S. Pat. No. 4,417,517. Tensioning is performed by means of swiveling a shaft, and arresting by means of a lever which must be specifically actuated.

The object of the invention is based on providing a device for clamping and/or tensioning.

In accordance with the invention, this object is attained by means of the characteristics of claim 1.

An advantage to be achieved by means of the invention resides in particular in that device permits clamping, or tensioning of packings and, at the same time, the positive arresting in the desired position. An actuation of separately designed devices for arresting, or releasing, and clamping, or tensioning, is not required. The device is simple to operate and can be accurately and dependably arrested in respect to occurring loading mechanisms.

A further advantage of the device is that arresting is provided by means of a positive connection, wherein the effective surfaces take place nearly perpendicularly to the circumferential surface and therefore normal in respect to the possible movement or force direction of the shaft or spindle. Release of the device by centrifugal forces, fluctuations or micro-movements, such as is possible in connection with non-positive connections or with resilient lever mechanisms, cannot occur.

Arresting can be performed in a simple self-locking manner. In the operating state of the cylinder, i.e. in the state of rest of the device for clamping and/or tensioning, the device is maintained positively arrested.

The arrangement with the arresting device acting positively in both directions of rotation of the spindle is particularly advantageous. This permits an exact, reproducible positioning of the shaft or spindle, and thus of the surfaces working together with the packing, and a defined position, independently of pretensioning of the device or the packing. The position of the spindle is important in particular for non-positive or positive holding or tensioning with the aid of profiled shafts, cams or gripping members on shafts. A small positional change of the surface in the circumferential direction, which works together with the packing, or an initially not quite exactly set position might cause the “opening” of the device, in particular, if the operation is performed at dead center (unstable equilibrium). By arresting the spindle in both adjustment directions, the unintentional displacement of the spindle by forces or movements which are oriented out of the channel, as well as directed into the channel is prevented. The former is caused, for example, by the pulling force of the packing or a centrifugal force, the latter for example by changes in length or evening-out of the packing over the circumference of the cylinder. If there is only a frictional connection between the packing and the surface of the spindle acting together with the packing, the packing can move further into the channel without the spindle being displaced in the circumferential direction and therefore turned out of its desired position.

An exemplary embodiment of the invention is represented in the drawings and will be described in greater detail in what follows.

Shown are in:

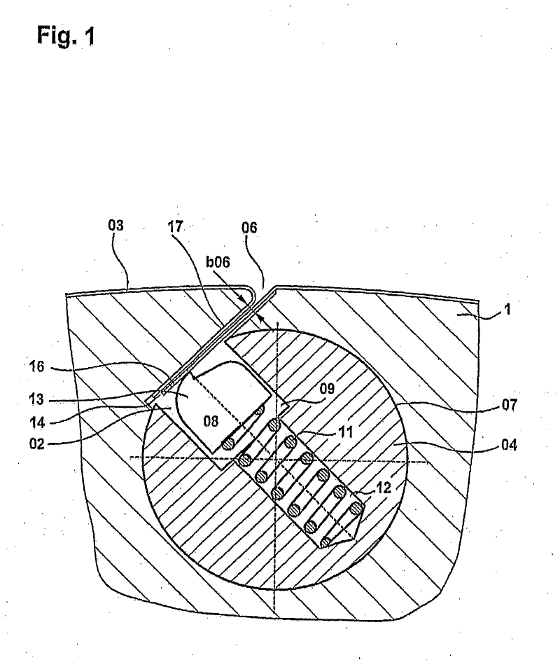

FIG. 1, a section through the channel with a clamping and/or tensioning device,

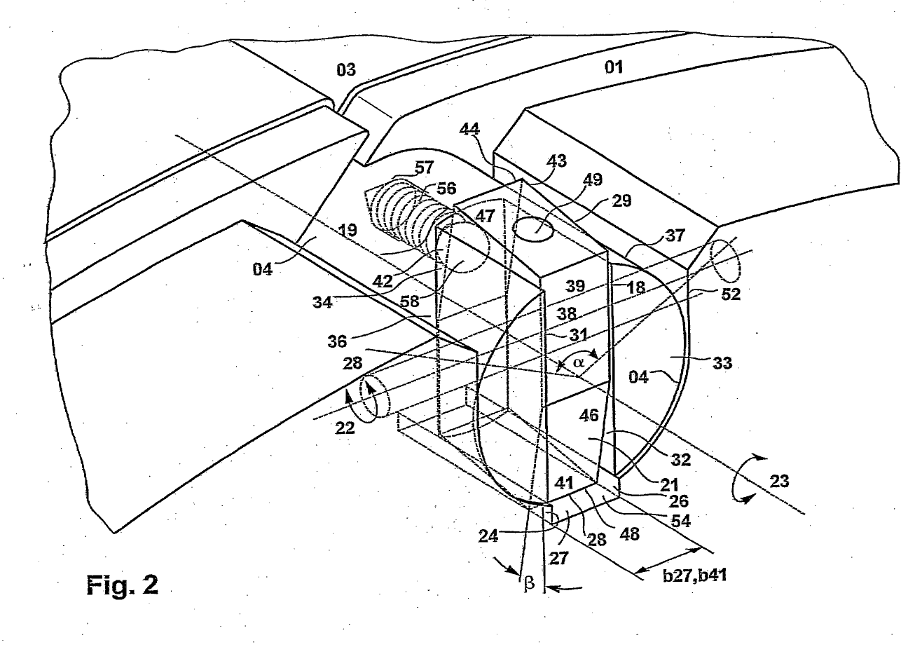

FIG. 2, an isometric drawing of the device for clamping and/or tensioning,

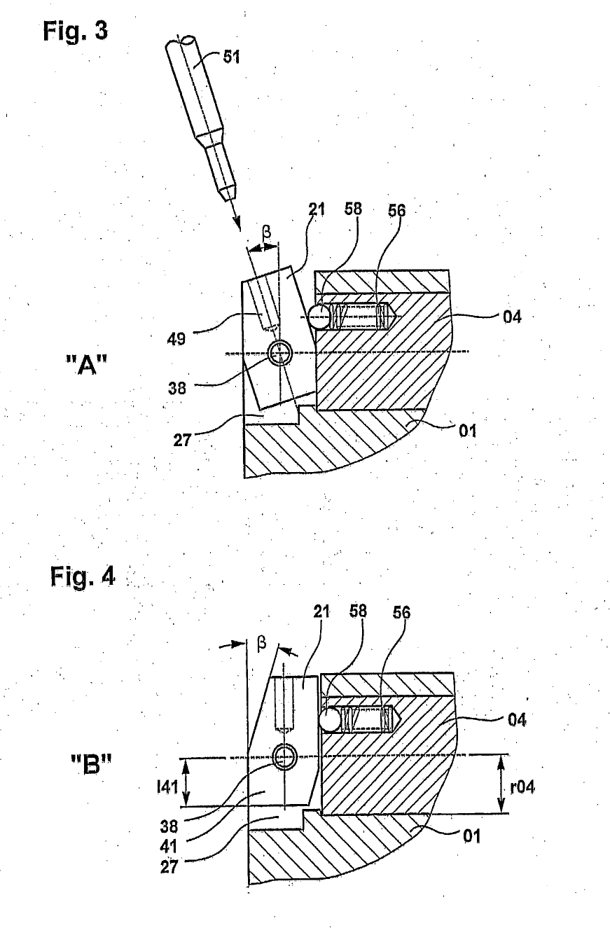

FIG. 3, a section through the device for clamping and/or tensioning in the arrested position A,

FIG. 4, a section through the device for clamping and/or tensioning in the released position B.

A device for the non-positive or positive holding and/or tensioning of at least one packing 03, for example a printing plate 03 on a forme cylinder 01, or a rubber blanket 03 of a transfer cylinder 01, is arranged in an axially extending channel 02 of a cylinder 01, for example a forme or a-transfer cylinder 01 of a printing press.

The actuation of the device for tensioning or holding the packing 03 is performed via a shaft 04, for example a spindle 04 with thrust pads, which is rotatably seated in the channel 02 of the cylinder 01.

The channel 02, which extends parallel with the cylinder axis, has a slit 06 on the surface shell of the cylinder 01, and a bore 07 located in the interior of the cylinder 01 and connected with the slit 06. The width b06 (for example b06=1 mm) of the slit 06 has slightly more than twice the thickness of the packing 03. A shaft 04, in the example a swivelable spindle 04, is arranged in the bore 07.

For clamping the packing 03, both ends of the packing 03 are fed into the slit 06 and are clamped by swiveling the spindle 04 with the aid of the clamping and/or tensioning device. The spindle 04 is provided with thrust pads 08 for this purpose. A hook strip 06, for example, which is arranged in a recess 09, for example a groove 09, extending in the axial direction on the circumference of the spindle 04, is used as the thrust pad 08 for the non-positive holding of the packing 03. The hook strip 08 is pressed in the radial direction out of the spindle 04 against the packing 03 by resilient elements 11, for example compression springs 11. The compression springs 11 are located in blind bores 12, which are spaced apart from each other in the axial direction and arranged in the bottom surface of the groove 09. The head of the hook strip 06, which cooperates with the packing 03, can be provided with a continuous hook, or several hooks 13 spaced apart from each other in the longitudinal direction of the spindle 04, which in the example act together with the edge 14 of the packing 03, or corresponding recesses 16 in the packing 03, for releasing the packing 03.

The non-positive connection between the wall 17, fixed in the cylinder, of the slit 06, the leading and trailing ends of the packing 03 and the hook(s) 13 arranged on the head of the hook strip 08 is greatest when the force exerted by the compressing springs 11 via the hook strip 08 acts perpendicularly on the ends of the packing 03.

However, the shaft 04 can also be a profiled shaft, an eccentric shaft, a spindle provided with cams or an eccentrically seated spindle. When turning the shaft 04, it either works together directly with the packing 03 in a frictionally connected or non-positive way by means of its active surface, or it actuates a movable mechanism, which cooperates with the packing 03. The surface of the shaft 04, which works together directly with the packing 03 in a frictionally connected or non-positive way with the packing 03 or the movable device is identified as the active surface.

The device for clamping and/or tensioning has essentially a recess 18 in the surface shell 19 of the shaft 04, in which a swivelably designed lever 21 is arranged. The swivel axis 22 assigned to the lever 21 extends nearly perpendicularly in respect to the swivel axis 23 of the shaft 04. For tensioning or clamping the packing 03, the shaft 04 is turned around its swivel axis 23, in an advantageous manner with the aid of the lever 21. For arresting or releasing the device, the lever 21 is swiveled around the swivel axis 22. The shape and position of the lever 21 are designed in such a way that in a first position, the arrested position A, the lever 21 acts together in a positive manner with the surfaces 24 and 26 of a pair of detents, for example the lateral surfaces 24 and 26 of a groove 27 fixed in the cylinder. In this arrested position A the shaft 04 is fixed in both directions in relation to its swivel axis 23. In a second position, the released position B, the lever 21 lies free in respect to the cylinder 01 and therefore permits turning of the shaft 04.

In the example, the recess 18 at one end of the shaft 04 is designed as a groove 18, which extends continuously through the shaft 04 perpendicularly in relation to the swivel axis 23 of the shaft 04. The groove 18 can also be arranged on a bearing journal assigned to the shaft 04, or on another extension assigned to the shaft 04. In a preferred embodiment, the groove 18 is located at the front of one end of the shaft 04 and divides the latter into two legs 28 and 29 with opposite surfaces 31 and 32 pointing toward the swivel axis 23 of the shaft 04, as-well as a surface 34 located between them and pointing in the direction of the front end 33 of the shaft 04. Each of the legs 28 and 29 have an outward oriented surface 36 and 37, which in the present example are a part of the surface shell 19.

A bolt 38, which extends corresponding to the swivel axis 22 and to which the lever 21 is swivelably attached, is arranged in the groove 18. The bolt 38 extends between the surfaces 31 and 32 of the legs 28 and 29 in the interior of the groove 18 preferably perpendicular in respect to the swivel axis 23 of the shaft 04. It allows swiveling of the lever 21 in a plane located parallel with the swivel axis 23 of the shaft 04 and perpendicular in respect to the swivel axis 22. The bolt 38 can be a shaft 38 passing through the lever 21 and be of one piece or divided, arranged on both sides of the lever 21. It can be non-positively or positively connected in the legs 28 or 29 or in the lever 21, wherein the rotatable seating, for example embodied as bushings or bearings, is then arranged correspondingly in the lever 21 or, in the second case, in the legs 28 and 29.

In the example, the lever 21 is embodied as a two-armed lever 21 in respect to the swivel axis 22. The bolt 38 acting as fulcrum defines a lever arm 39 to be actuated and a lever arm 41, which acts as a ratchet 41. The lever 21 has two lateral surfaces 42 and 43, which lie nearly parallel opposite surfaces 31 and 32 of the legs 28 and 29, as well as a surface 44 facing the surface 34 and a surface 46 located diametrically opposite the surface 44 on the lever 21. In the example the lever 21 is designed to be approximately cuboid and it has two front ends 47 and 48 on opposite ends.

The lever 21 can also be embodied as a one-armed lever. In this case the ratchet 41 is for example a protrusion 41, which projects laterally out of the surface 46 on the lever arm 39 and which, in the arrested position A, enters into the groove 27 fixed on the cylinder.

The front face 47 assigned to the lever arm 39 to be actuated can have an opening 49, for example a bore 49, into which an actuating means 51, for example an actuating arbor 51, is positively inserted for extending the lever arm 39. The positive connection can also be designed in the opposite manner by means of an opening 49 in the actuating means 51 and a protrusion corresponding to the shape on the lever arm 39.

The dimensions and the position of the lever arm 41 acting as a ratchet 41 have been selected in such a way that in the released position B its front face 48 terminates flush with the surface shell 19, for example, or at least does not project past it, but in the arrested position A projects past the surface shell 19 and acts positively together with the lateral surfaces 24 and 26 of the groove 27. In the example the ratchet 41 is a part of the cuboid two-armed lever 21 and has a length 141 and a width b41. The bolt 38 arranged perpendicular in respect to the swivel axis 23 of the shaft 04 passes perpendicularly through the surfaces 42 and 43 of the lever 21. The length 141 of the ratchet 41 has been selected to be approximately equal to the radius r04 of the shaft 04, so that the front face 48 extends flush nearly in an imagined extension of the surface shell 19. When swiveling the lever 21 over an angle β into the arrested position A, the edge defined by the surfaces 48 and 46 moves out of the imagined course of the surface shell 19. It is possible in an advantageous manner for the surface 46 of the cuboid lever 21 to be beveled by the angle β in the area of the lever arm 39 in such a way that in the arrested position A the lever 21 does not project out of the front face of the cylinder 01. In the same way the surface 44 of the cuboid lever 21 can be beveled by the angle β in the area of the lever arm 41 in such a way that in the arrested position A the lever 21 does not project into the shaft 04.

The position and shape of the ratchet 41 are matched to the shape and distance of the surfaces 24 and 26 respectively acting together with the ratchet 41 as detent, as well as to the positioning of the shaft 04 in the cylinder 01.

In the example, the end of the shaft 04, which projects from the channel 02 and is provided with a groove 18 at the front, is positively seated, rotatable around the swivel axis 23, in a bore 52 of the front wall 53 of the cylinder 01. However, for the purpose of operating the lever 21 arranged in the groove 21, the shaft 04 is not completely surrounded by the front wall 53 of the cylinder 01. The opening angle α depends on the required travel of the lever 21 for actuating the shaft 01 and for example can be 290°.

The groove 27 acting together with the ratchet 41 is arranged in the bore 52 parallel with the swivel axis 23 and has a base 54 and two lateral surfaces 24 and 26, which act together with the surfaces 42 and 43 of the ratchet 41. It is also possible for several grooves 27 to be arranged in the bore 52 in the circumferential direction.

The ratchet 41 can also act together with different surfaces 24 and 26 arranged on the cylinder 01, which in the arrested position A positively absorb the force transmitted via the surfaces 42 and 43 of the lever 21 and acting tangentially in relation to the surface shell 19 of the shaft 04. This can be, for example, a segment of a hollow wheel with teeth on the inside, having the respective tooth flanks as surfaces 24 and 26, and with a ratchet 41 embodied as a trapezoidal or triangular prism working together with them.

The inclinations of the surfaces 24 and 26 working together with the lever 21 as detents, for example embodied as lateral surfaces 24 and 26 of a groove 27, are arranged in an advantageous manner nearly parallel with the surfaces 42 and 43 of the lever 21 when the shaft 04 and the lever 21 are in the arrested position A. In an advantageous manner the surfaces 42, 43, 24 and 26 approximately extend on a plane parallel with the swivel axis 23, and thus in the swivel plane of the lever 21. It is possible to achieve a positive connection fixed against a possible rotation of the shaft 04, along with as even as possible a surface pressure, for example by means of the arrangement of the surfaces 42, 43, 24 and 26 in a plane extending nearly parallel with the swivel axis 23 and perpendicularly in respect to the tangent of the surface shell 19 of the shaft 04. In order to avoid play in case of a non-positive connection, it is possible to select the width b41 of the ratchet 41 nearly equal to the width b27 of the groove 27, or nearly equal to the clear distance between the surfaces 24 and 26 respectively acting as detents.

The design of the end of the ratchet 41 acting together with the groove 27 with lateral faces 42 and 43 approaching each other in a slightly wedge-shaped manner in the direction toward the groove 27 is advantageous. In this case the width b27 of the groove 27, or the clear distance between the surfaces 24 and 26 has been selected to be greater than the narrow side facing the groove 27, and less than the wider side of the wedge-shaped end of the ratchet 41. In the arrested position A, the ratchet 41 is located as deeply as possible in the groove 27 and constitutes a positive, play-free connection in respect to the possible swivel direction of the shaft 04.

In a preferred embodiment, the lever 21 is in the arrested position A when it is not in operation and prevents the unintentional rotation of the shaft 04. For this purpose an element 56 with resilient action nearly parallel with the swivel axis 23 is arranged in the surface 34 of the shaft 04 and cooperates directly or indirectly with the surface 44 in the area of the lever arm 39. In the example the surface 44 has a blind bore 57, in which a spring 56 and a ball 58 are arranged. The spring 56 is supported on the bottom of the blind bore 57 and presses the ball 58, which is arranged in the mouth of the blind bore 57, against the surface 44 of the lever arm 39.

In all embodiments, the recess 18, an adjustable means 21 designed as a lever 21, and the two surfaces 24 and 26, each acting together with the lever 21 as detents, mutually affect each other in their detailed shaping and arrangement. The arrangement of a lever 21, which is swivelable in a plane which extends nearly parallel with the swivel axis 23 of the shaft 04 and has a ratchet 41 which, by means of its lateral surfaces 42 and 43 cooperates with the surfaces 24 and 26 each acting together with the other as detents, is common to all possible embodiments. In the arrested position A of the lever 21 the shaft 04 is fixed in both directions in respect to its swivel axis 23. In a different design, the said surfaces 24, 26, 42 and 43 can also be embodied as contact lines or contact points.

It is also possible, for example via a gear of toothed wheels, to arrange the swivel movement for clamping/tensioning not directly around the swivel axis 23 of the shaft 04, but around an axis parallel with this swivel axis.

The mode of functioning of the device of the invention for actuating a clamping and/or tensioning device is as follows:

For changing the packing 03 on the cylinder 01, the lever 21, which is in the arrested position A, is swiveled into the released position B by swiveling the lever arm 39 against the force of the resilient element 56. In the process the ratchet 41 moves out of the groove 27 and is in the released position B. The shaft 04, for example the swivelable spindle 04, can now be rotated on the lever arm 39 around its swivel axis 23 with or without actuating means 51. In the example, the shaft 04 is initially rotated into the direction in which the hooks 13 of the hook strip 08 arranged on the spindle 04 extend below the edge 14, or the recesses 14 of the packing 03. Thereafter the spindle 04 is rotated in the opposite direction, whereupon the hooks 13 push the packing 03 out of the channel 02.

For clamping, or tensioning a fresh packing 03, the shaft 04, for example the spindle, is initially placed in a position in which the hooks 13 free the channel 02 for the packing 03. In the example the spindle 04 is arranged in this position in such a way that the hooks 13 point radially out of the cylinder 01, and not into the slit 06. Both ends of the packing 03 are introduced through the slit 06 into the channel 02 so that they come to rest between a wall 53, fixed on the cylinder, of the slit 06 and the spindle 04. Thereafter the spindle 04 is swiveled around its swivel axis 23 by means of the lever arm 39 so far that the ratchet 41 reaches the position defined by the groove 27 in the cylinder 01. In this position the hooks 13 act together with the packing 03, and the force of the compression springs 11 acts nearly normally on the packing 03. With the release of the lever arm 39 the ratchet 41 is swiveled via the resilient element 56 into the groove 27 and is maintained there in a self-locking manner, by means of which the shaft 04 is fixed in the predetermined position against rotating in either possible direction.

List of Reference Symbols

01 Cylinder, forme cylinder, transfer cylinder

02 Channel (01)

03 Packing, printing plate, rubber blanket

04 Shaft, spindle

05 -

06 Slit (01)

07 Bore (53)

08 Thrust pad, hook strip

09 Recess, groove (04, 08)

10 -

11 Resilient element, copression spring (09)

12 Blind bore (04)

13 Hook (08)

14 Edge (03)

15 -

16 Recess (03)

17 Wall (06)

18 Recess, groove (04, 21)

19 Surface shell (04)

20 -

21 Lever, swivelable means

22 Swivel axis (21)

23 Swivel axis (04)

24 Surface (27)

25 -

26 Surface (27)

27 Groove (01)

28 Leg (04)

29 Leg (04)

30 -

31 Surface (28)

32 Surface (28)

33 Front face (04)

34 Surface (18)

35 -

36 Surface (28)

37 Surface (29)

38 Bolt, shaft (21)

39 Lever arm (21)

40 -

41 Lever arm, ratchet, projection (21)

42 Surface (21)

43 Surface (21)

44 Surface (21)

45 -

46 Surface (21)

47 Front face (21)

48 Front face (21)

49 Opening, bore (21, 39)

50 -

51 Actuating means, actuating arbor (49)

52 Bore (01)

53 Wall (01)

54 Base (27)

55 -

56 Resilient element, spring

57 Blind bore (09)

58 Ball (09)

A Arrested position

B Released position

b27 Width, clear distance (27)

b41 Width (41)

b06 Width (06)

141 Length (41)

r04 Radius (04)

α opening angle

β Angle

1. A device for clamping and/or tensioning a packing (03) on a cylinder (01), wherein clamping and/or tensioning, as well as the arresting of a shaft (04) in respect to is swivel axis (23) can be performed with a single means (21) and, for clamping and/or tensioning, the means (21) can be swiveled around an axis which is parallel with the swivel axis (23) of the shaft, characterized in that for arresting the means (21) can be swiveled around a swivel axis (22) which extends perpendicular in respect to the swivel axis (23) of the shaft (04).

2. The device in accordance with claim 1, characterized in that for clamping and/or tensioning the means (21) can be swiveled around the swivel axis (23) of the shaft (04) itself.

3. The device in accordance with claim 1, characterized in that in an arrested position (A) the shaft (04) is positively fixed in place in respect to its swivel axis (23) in both swivel directions.

4. The device in accordance with claim 1, characterized in that the means (21) embodied as a lever (21) is swivelably arranged in a plane extending nearly parallel with the swivel axis (23) of the shaft (04), and that in the arrested position (A) the lever (21) is arranged to act together with two surfaces (24, 26).

5. The device in accordance with claim 4, characterized in that the swivelable means (21) is arranged in a recess (18) of the shaft (04), and that the surfaces (24, 26) acting together with the swivelable means (21) are arranged on the cylinder (01).

6. The device in accordance with claim 4, characterized in that the swivelable means (21) has a ratchet (41) with two surfaces (42, 43), which extend nearly perpendicular in respect to the surface shell (19) of the shaft and, in the arrested position (A), act together with the two surfaces (24, 26).

7. The device in accordance with claim 6, characterized in that in the arrested position (A) the surfaces (42, 43) of the ratchet and the surfaces (24, 26) extend nearly parallel with each other.

8. The device in accordance with claim 5, characterized in that the swivelable means (21) is swivelably arranged on a shaft (38), which extends in the recess (18) nearly perpendicular in respect to the swivel axis (23) of the shaft (04).

9. The device in accordance with claim 5, characterized in that the recess (18) is embodied on one front face (33) of the shaft (04) as a groove (18) extending radially through the shaft (04).

10. The device in accordance with claim 5, characterized in that the two surfaces (24, 26) are embodied as surfaces of a groove (27).

11. The device in accordance with claim 5, characterized in that the surfaces (24, 26) are arranged in a bore (52), which receives the shaft (04), of a front wall of the cylinder (01).

12. The device in accordance with claim 1, characterized in that the swivelable means (21) is embodied as a two-armed lever (21), having a first lever arm (39) to be operated, and a second lever arm (41).

13. The device in accordance with claims 6 and 12, characterized in that the two-armed lever (21) is designed approximately cuboid, wherein the second lever arm (41) constitutes the ratchet (41) at the same time.

14. The device in accordance with claims 6 and 12, characterized in that the ratchet (41) is a part of the second lever arm (41).

15. The device in accordance with claim 1, characterized in that the arrestment of the shaft (04) in the arrested position (A) takes place in a self-locking manner.

16. The device in accordance with claim 15, characterized in that the arrestment of the shaft (04) in a self-locking manner is provided by a resilient element (56), which acts together with the swivelable means (21).

17. The device in accordance with claim 16, characterized in that the resilient element (56) is arranged in a blind bore (12) located in the shaft (04).

18. The device in accordance with claim 1, characterized in that the shaft (04) is arranged in a printing press.

19. The device in accordance with claim 1, characterized in that the packing (03) is embodied as a printing plate (03) on a forme cylinder (01).

20. The device in accordance with claim 1, characterized in that the packing (03) is embodied as a rubber blanket (03) on a transfer cylinder (01).

21. The device in accordance with claim 1, characterized in that the shaft (04) is arranged to have a channel (02) extending axially in respect to the cylinder (01), wherein the channel (02) has a slit (06) extending axially on the cylinder for receiving the two ends of the packing (03), and a bore (07) extending axially in the cylinder (01) and receiving the shaft (04), which is connected with the slit (06).

22. The device in accordance with claim 1, characterized in that at least one thrust element (08), extending in the radial direction of the shaft (04), is resiliently arranged on the shaft (04).

23. The device in accordance with claims 21 and 22, characterized in that a wall (17) of the slit (06) and the shaft (04) with its assigned thrust element (08) are arranged in such a way that, in the clamping position of the shaft, the two ends of the packing (03) are non-positively connected with the wall (17) of the slit (06) and the thrust element (08) acting together with it.
